(19) United States
(12) Patent Application Publication
(10) Pub. No.: US 2014/0177291 A1
(43) Pub. Date: Jun. 26, 2014

(54) SELF-EXCITED PUSH-PULL CONVERTER

(71) Applicants: Baojun Wang, Guangzhou (CN); De Xie, Guangzhou (CN); Wei Liu, Guangzhou (CN)

(72) Inventors: Baojun Wang, Guangzhou (CN); De Xie, Guangzhou (CN); Wei Liu, Guangzhou (CN)

(21) Appl. No.: 13/979,653

(22) PCT Filed: Jan. 11, 2012
(86) PCT No.: PCT/CN12/70205

§ 371 Date: Jul. 14, 2013

(30) Foreign Application Priority Data
Aug. 23, 2011 (CN) 201110242377.4

(51) Int. Cl. H02M 3/337

(52) U.S. Cl. CPC H02M 3/337
USPC 363/22

(57) ABSTRACT

A self-excited push-pull converter, which comprises a Royer circuit, wherein an inductor is further connected between a supply terminal of said Royer circuit and a center tap of primary windings of a transformer in said Royer circuit, an inductance amount of said inductor is less than 1/10 of the inductance amount of one of the primary windings of the transformer, and the center tap of said primary windings is a connection point between the two primary windings of said transformer. The self-excited push-pull converter of the present invention show high consistency, easy adjustment, low requirements on the manufacturing process and good short circuit protection performance.

### TECHNICAL FIELD

The present invention relates to a self-excited push-pull converter, and more specifically, to a self-excited push-pull converter in DC-DC or DC-AC in the industrial control and lighting industry.

### BACKGROUND

The circuit structure of some existing self-excited push-pull converters are based on the self-excited oscillating push-pull triode single-transformer DC converter invented by American G. H. Royer in 1955, which was also the beginning of high-frequency control circuits, and others are based on the self-excited push-pull dual-transformer circuit invented by American Jen Sen in 1957, which is later referred to as self-oscillating Jensen circuit. These two types of circuits are later collectively called as self-excited push-pull converters. Compared with the Jensen circuit, the Royer circuit boasts such an advantage that by the circuit design, it can achieve self protection without burning a triode used for push-pull when output load short circuit occurs. Principles & Design of Switching Mode Power Supply (ISBN 7-121-00211-6), published by Publishing House of Electronics Industry, describes in pages 67-70 the circuit composition and implementation principles of self-excited push-pull converters, wherein main circuit configurations are the well-known Royer circuit and self-oscillating Jensen circuit. A self-excited push-pull converter adopting a Royer circuit structure is mainly composed of a pair of triodes used for push-pull and a magnetic core having a hysteresis loop and is push-pull oscillate-driven using magnetic core saturation characteristics. Its oscillating frequency is a function of supply voltage, and can be calculated as follows:

$$f = \frac{Vs}{4 BwSN} \times {10}^{4} Hz \qquad Equation ( 1 )$$

Where f is the oscillating frequency, Bw is the operating magnetic induction intensity (T), N is the number of coil turns, and S is the magnetic core's effective cross-sectional area.

In the prior art a self-excited push-pull converter adopting a Royer circuit structure achieves short circuit protection through leakage inductance of transformers. All transformers have leakage inductance or, in other wards, there is no ideal transformer. Leakage inductance of transformers means that not all magnetic field lines produced by a primary coil can pass through a secondary coil, so the inductance that produces magnetic leakage is called leakage inductance. Usually the secondary coil is used for output and is also called secondary side. When the secondary coil is directly short-circuited, the primary coil is found to still have an inductance, the amount of which is approximately considered as leakage inductance. The primary coil and primary winding are also referred to as primary side.

FIG. 1 shows a common self-excited push-pull converter in the prior art, which adopts a Royer circuit structure, comprising a filter capacitor C, a bias resistor R1, a starting capacitor C1, a first triode TR1, a second triode TR2 and a transformer B, wherein transformer B comprises: a first primary winding N_{P1} and a second primary winding N_{P2}, wherein a dotted terminal of second primary winding N_{P2} is connected to an undotted terminal of first primary winding N_{P1}, their connection point being a center tap of the primary windings; a first feedback winding N_{B1} and a second feedback winding N_{B2}, wherein a dotted terminal of first feedback winding N_{B1} is connected to an undotted terminal of second feedback winding N_{B2}, their connection point being a center tap of the feedback windings; and a secondary winding N_{S}. One terminal of filter capacitor C is a supply terminal Vin of the converter, and the other terminal is a supply reference terminal GND of the converter. First triode TR1 is connected with an emitter of second triode TR2, their connection point being connected to supply reference terminal GND. A base of first triode TR1 is connected to an undotted terminal of first feedback winding N_{B1}, and a collector thereof is connected to a dotted terminal of first primary winding N_{P1}. A base of second triode TR2 is connected to a dotted terminal of second feedback winding N_{B2}, and its collector is connected to an undotted terminal of second primary winding NP2. Supply terminal Vin has one path connected to the center tap of the primary windings and has the other path connected to the center tap of the feedback windings via bias resistor R1. Starting capacitor C1 and bias resistor R1 are connected in parallel. Output winding Ns is the converter's output and is connected with the transformer's load. The circuit's secondary side may be outputted by a well-known full-wave rectifying circuit as shown in FIG. 2. The transformer's output waveform is approximate square waves. The circuit has high conversion efficiency. In such a circuit structure, starting capacitor C1 connected in parallel with bias resistor R1 may be removed in many occasions such as for a high operating voltage, thereby avoiding the impact of starting capacitor C1 on first triode TR1 and second triode TR2 when the converter is switched on. When the converter's load is short-circuited, it is equivalent to the situation where the inductance amount of first primary winding NP1 and second primary winding Np2 is reduced to a very small value and the circuit enters into high-frequency self-excited push-pull oscillation. With reference to Equation (1), when the load is short-circuited, the number of effective coil turns is equivalently reduced due to short circuit. This corresponds to the situation where the product of SN in Equation (1) decreases while the operating frequency increases. In turn, the frequency increase will cause the circuit to depart from magnetic core saturated oscillation but enter into LC loop high-frequency oscillation. By controlling leakage inductance of transformer B, the self-excited push-pull oscillating frequency can rise significantly. According to the well-known transformer theory, the rise of the oscillating frequency is usually coupled with a decrease of the transmission efficiency of transformer B. The energy consumption of the secondary side caused by short circuit is not very large, and the consumption of the primary side also falls with the rise of the self-excited push-pull oscillating frequency. Subsequent to the rise of the self-excited push-pull oscillating frequency, the transmission efficiency of transformer B decreases. The leakage inductance caused by short circuit goes up to some extent, i.e. a leakage inductance value increases. Eventually, the circuit's oscillating frequency is maintained at a high frequency. The above implementation process of short circuit protection may be summarized as below: load short-circuited→transformer's primary inductance amount fall→circuit's push-pull oscillating frequency rise→transformer's transmission efficiency drop→leakage inductance value increase under a new operating frequency→circuit's push-pull oscillating frequency maintained at a certain point. In practice, a self-excited push-pull converter with a Royer circuit structure operates at a frequency of 100 KHz in normal operation. However, in case of short circuit, its operating frequency may go above 1 MHz.

Since there exists distributed capacitance between turns of the coil of transformer B of the self-excited push-pull converter using a Royer circuit structure as shown in FIG. 1, it corresponds to an equivalent circuit of the coil shown in FIG. 4. The distributed capacitance of the coil is equivalent to a capacitor as shown in the figure, and a resistor shown in the figure is an equivalent resistor of the coil. Thus, when the converter implements short circuit protection by using leakage inductance, transformer B, first triode TR1 and second triode TR2 constitute an LC oscillating loop. An equivalent circuit of this oscillating loop is as shown in FIG. 5, wherein a capacitor C_{F} is the loop's distributed capacitance, comprising output capacitance of first triode TR1 and second triode TR2, distributed capacitance of the primary windings (first primary winding N_{P1} and second primary winding N_{P2}) of transformer B as well as distributed capacitance between wires. First leakage inductance L_{DP1} and second leakage inductance L_{DP2} are leakage inductance of the two primary windings of transformer B, respectively. Since first triode TR1 and second triode TR2 are alternately turned on, the collector of one of the triodes is always equivalently grounded due to saturated conductivity. This corresponds to a situation where two terminals in the LC oscillating loop are alternately grounded using a high-speed switch, i.e. equivalent to the fact that one terminal in the LC oscillating loop is always grounded and the other terminal is connected at supply terminal Vin. Since the LC oscillating loop is amplitude-limited by a voltage inputted from supply terminal Vin, even thought the circuit's operating frequency rises when the load is short-circuited, the LC oscillating loop is parallel limited by supply terminal Vin, which is as if the LC oscillating loop is short-circuited or, in other words, the quality factor Q value of the LC oscillating loop is very low, continuous energy supplement is thus required in order to maintain oscillation. As such, the internal energy consumption of the converter is significant.

FIG. 3 shows a self-excited push-pull converter that is commonly used in the lighting industry in the prior art. This self-excited push-pull converter is used for driving fluorescent lamps and energy saving lamps, has a scientific name of “collector resonant Royer circuit” or “cold cathode fluorescent lamp inverter (CCFL inverter,” and thus is also referred to as CCFL inverter or CCFL converter for short. Its characteristics are as follows: on the basis of a self-excited push-pull converter (as shown in FIG. 1) adopting a Royer circuit structure, a supply terminal Vin is connected via a damped inductor L1 to a center tap of primary windings of transformer B, usually an inductance amount of damped inductor L1 being more than 10 times as large as an inductance amount of a first primary winding N_{P1} or a second primary winding N_{P2}; in the meanwhile, a collector of a first triode TR1 is connected via a resonant capacitor C_{L} to a collector of a second triode TR2; resonant capacitor C_{L} and transformer B form a well-known LC oscillating loop, wherein C is an capacitance amount of resonant capacitor C_{L} and L is a total inductance amount of the primary windings of the transformer. The inductance of first primary winding N_{P1} is equal to that of second primary winding N_{P2}, and total inductance amount L_{ALL} of the primary windings of transformer B is 4 times as large as the inductance amount of first primary winding N_{P1}. By means of the LC oscillating loop, the output of the self-excited push-pull converter adopting the collector resonant Royer circuit structure is sine waves or approximately sine waves. For a converter in such a circuit form, i.e. using transformer leakage inductance technique to repetitively regulate leakage inductance of push-pull transformer B, since the inductance amount of L1 is quite large, it is difficult to obtain a good output short circuit protection performance. Under an expected high frequency, it is difficult to supplement energy for the LC oscillating circuit formed by resonant capacitor CL and the leakage inductance of transformer B. When the converter's load is short-circuited, the circuit cannot enter a high-frequency oscillation status. Since the leakage inductance of transformer B is small, the circuit stops oscillation, and a resistor R1 provides a bias current to bases of triodes TR1 and TR2. At this point, it occurs that first triode TR1 and second triode TR2 are DC turned on via damped inductor L1, which leads to the result that first triode TR1 and second triode TR2 are burned because of a large current and a large collector-to-emitter voltage drop in a short time.

To sum up, the self-excited push-pull converter with a Royer circuit structure in the prior art has the following disadvantages:

1. The production of transformers needs to meet strict process requirements, and the product consistency can be difficult to maintain.

As the converter achieves short circuit protection through leakage inductance, to obtain good short circuit protection performance, the requirements for the leakage inductance of the transformer are very strict. Therefore, the process of winding transformers is subjected to strict requirements.

2. It is difficult to strike a balance between the efficiency and short circuit protection performance for the existing Royer self-excited push-pull converter.

When winding a transformer, it is a common practice to leave a big gap between the primary side and the secondary side. This results in a large leakage inductance and a good performance of short circuit protection. However, large leakage inductance lowers the overall conversion efficiency. That is, the existing Royer self-excited push-pull converter is self-contradictory in terms of efficiency and short circuit protection performance. It is quite often that good short circuit protection performance is achieved at the expense of conversion efficiency, or the conversion efficiency is good while short circuit protection performance is poor.

3. For a Royer self-excited push-pull converter circuit (as shown in FIG. 3) with sine-wave output to be used in the industrial control and lighting industry, the prior art design cannot achieve good protection of output short circuit. When the load is short-circuited, due to the existence of damped inductor L1, the circuit cannot operate under a higher frequency, and first triode TR1 and second triode TR2 will be burned in a short time.

4. Because the existing Royer self-excited push-pull converter has large power consumption, if the load short circuit lasts a little bit longer, say a few minutes to half an hour, the circuit is likely to be destroyed by heating.

### SUMMARY

It is an object of the present invention to provide a self-excited push-pull converter, which can eliminate the above-discussed drawbacks in the prior art, achieves good consistent performance of short circuit protection, strikes a proper balance between operating efficiency and short circuit protection performance, imposes lower requirements on the manufacturing process of the transformers having leakage inductance, and is capable of operating long hours without being destroyed following an occurrence of load short circuit.

The object of the present invention is achieved by the following technical measure:

A self-excited push-pull converter comprises a Royer circuit, wherein an inductor is further connected between a supply terminal of the Royer circuit and a center tap of primary windings of a transformer in the Royer circuit, the inductance amount of the inductor is 1/10 below of the inductance amount of one of the primary windings of the transformer, and the center tap of the primary windings is a connection point of the two primary windings of the transformer.

As a particular embodiment of the present invention, the inductor L_{N} is formed by wiring of a printed circuit board.

As another embodiment of the present invention, the inductor L_{N} is formed by connecting a lead of the center tap of the primary windings in series with a magnetic bead or a magnetic ring.

The present invention may also be implemented by another technical measure: a self-excited push-pull converter comprises a collector resonant Royer circuit, further comprising an inductor and a capacitor, wherein a center tap of primary windings of the transformer in the collector resonant Royer circuit is connected to the supply terminal of the collector resonant Royer circuit via an inductor and a damped inductor in the collector resonant Royer circuit, the inductance amount of the inductor is less than 1/10 of the inductance amount of one of the primary windings of the transformer, the center tap of the primary windings is a connection point of the two primary windings of the transformer, the connection point of the damped inductor and the inductor is connected via the capacitor to a supply reference terminal of the collector resonant Royer circuit.

As an embodiment of the present invention, said inductor L_{N} is formed by wiring of a printed circuit board.

As another embodiment of the present invention, said inductor L_{N} is formed by connecting a lead of the center tap of said primary windings in series with a magnetic bead or a magnetic ring.

Compared with the prior art, the present invention has the following advantageous effects:

1. After adding a low-cost inductor or a low-cost inductor and capacitor, the fabrication and production process of transformers is simple, and the short circuit protection performance has good consistency.

2. The efficiency and short circuit protection performance of the self-excited push-pull converter can be each adjusted independently, thereby enabling a proper balance between a high operating efficiency and a good short circuit protection performance for the converter.

3. When load short circuit occurs, the Royer self-excited push-pull converter of the present invention can stably operate for many hours, thereby improving the short circuit protection performance.

4. The self-excited push-pull converter of the present invention that outputs sine-wave signals can be used in the industry of industrial control and lighting and equally achieve the three advantageous effects described above.

When an inductor is serially connected between the power-supply source terminal and the center tap of the main transformer and the inductor's inductance amount is such that little impact is exerted on the circuit's conversion efficiency in normal operation but, when an output short circuit occurs, the circuit operates in a high-frequency oscillation mode and, due to the inductor's characteristics that pass low frequencies but block high frequencies, a large voltage drop is produced, and the energy transmission of the transformer to the output short terminal end is decreased, thereby lowering the circuit's operating current during output short circuit and reducing the circuit's power consumption.

For the collector resonant Royer circuit, the center tap of primary windings of transformer B is connected to a supply terminal Vin via inductor L_{N} and damped inductor L₁ in the collector resonant Royer circuit in this order, and the connection point of damped inductor L₁ and inductor L_{N} is connected to a supply reference terminal. During normal operation, the newly added capacitor C_{N} in the present invention has a large capacitive resistance, producing such little effect almost as if it did not exist. Inductor L_{N} being serially connected has a small inductance amount, thereby having almost no impact on the original circuit performance. The two newly added elements exert no impact on the circuit output, which is of sine waves or approximately sine waves. Upon output short circuit, however, the circuit's oscillating frequency rises, and damped inductor L₁ and newly-added capacitor C_{N} constitute an LC filter loop. At this point, capacitor C_{N} has small capacitive resistance, which is equivalent to being alternately grounded for high-frequency signals. Thus, high-frequency oscillation is maintained thanks to the existence of capacitor C_{N}. Also, due to inductor L_{N}'s characteristics of passing low frequencies and blocking high frequencies, a large voltage drop is produced in a high-frequency oscillation operating mode and the energy transmission of the transformer to the short-circuited output is decreased, thereby lowering the circuit's operating current during output short circuit and reducing the circuit's power consumption.

If the leakage inductance of the transformer is small and high-frequency oscillation is higher, then a voltage drop at the serially-connected inductor will increase, which further limits the energy transmission of the transformer to the short-circuited output and achieves good consistency of short circuit protection.

### BRIEF DESCRIPTION OF THE DRAWINGS

A further detailed illustration is presented below to the present invention with reference to the accompanying drawings and the specific embodiments.

FIG. 1 is a schematic circuit diagram of a self-excited push-pull converter adopting a Royer circuit structure in the prior art;

FIG. 2 is a schematic circuit diagram of a well-known full-wave rectifying circuit;

FIG. 3 is a schematic circuit diagram of a collector resonant Royer circuit in the prior art;

FIG. 4 is an actual equivalent schematic circuit diagram of a well-known inductor;

FIG. 5 is an equivalent schematic circuit diagram of a main circuit of the circuit shown in FIG. 1 when implementing short circuit protection by leakage inductance;

FIG. 6 is a schematic circuit diagram according to Embodiment 1 of the present invention;

FIG. 7 is an output waveform diagram during circuit normal operation according to Embodiment 1 of the present invention;

FIG. 8 is an equivalent schematic circuit diagram of a main circuit of the circuit shown in FIG. 6 when implementing short circuit protection;

FIG. 9 is a schematic circuit diagram according to Embodiment 2 of the present invention;

FIG. 10 is a waveform diagram of a first triode collector of the circuit shown in FIG. 1 when implementing short circuit protection;

FIG. 11 is a schematic circuit diagram of a conversion efficiency test circuit of a self-excited push-pull converter; and

FIG. 12 is a waveform diagram of a first triode collector of the circuit shown in FIG. 6 when implementing short circuit protection.

### DETAILED DESCRIPTION OF PARTICULAR EMBODIMENTS

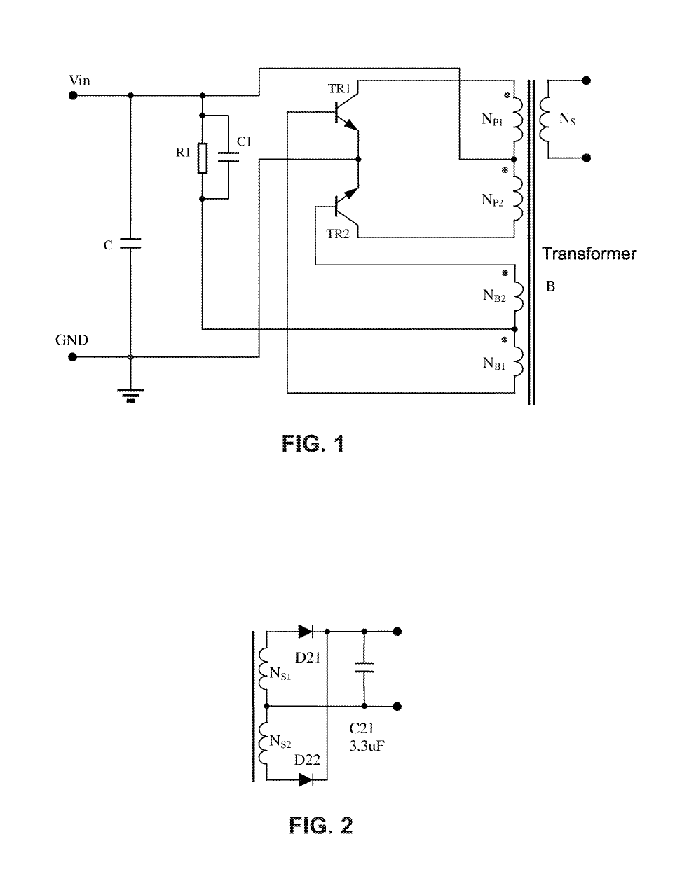

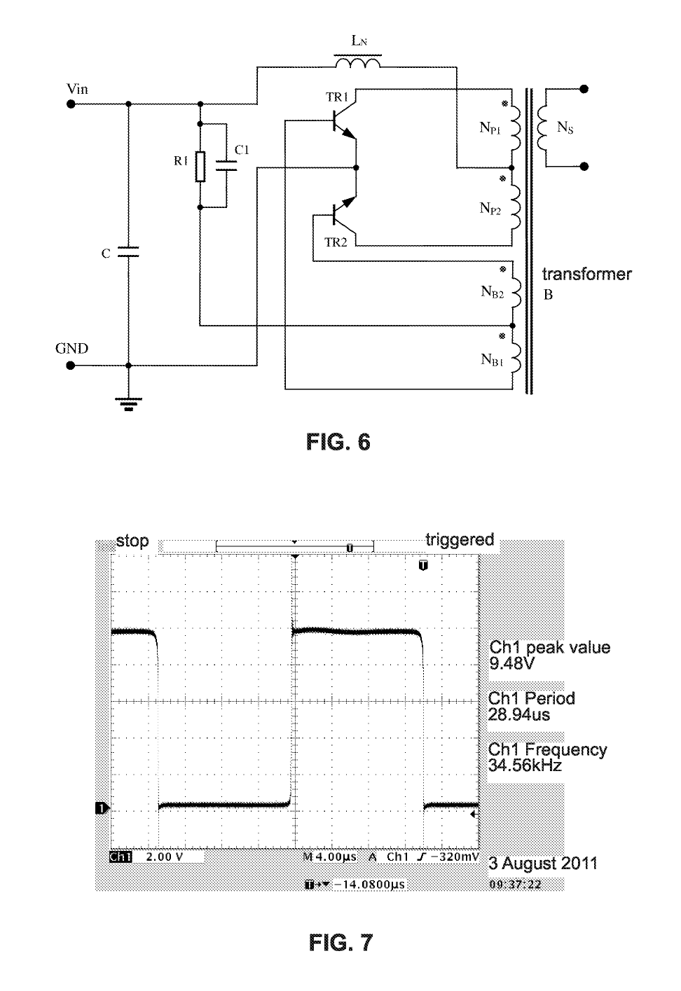

FIG. 6 shows a self-excited push-pull converter according to Embodiment 1 of the present invention, which comprises: a filer capacitor C, a bias resistor R1, a starting capacitor C1, a first triode TR1, a second triode TR2, a transformer B as well as an inductor L_{N}. Its circuit structure is substantially identical to that of a self-excited push-pull converter (as shown in FIG. 1) adopting a Royer circuit structure in the prior art, and the difference only lies in that a supply terminal Vin is connected via newly added inductor L_{N} to a center tap of primary windings of transformer B, the inductance amount of inductor L_{N} is less than 1/10 of that of one of the primary windings (N_{P1}, N_{P2}) of transformer B, and the center tap of the primary windings is a connection point between a first primary winding N_{P1} and a second primary winding N_{P2}.

When the two primary windings (first primary winding N_{P1} and second primary winding N_{P2}) of transformer B have different values, the inductance amount of inductor L_{N} is less than 1/10 of that of one of the two primary windings that a smaller inductance amount between the two.

When the converter operates normally, since the inductance amount of inductor L_{N} is far less than that of first primary winding N_{P1} or second primary winding N_{P2}, inductor L_{N} has little influence on the circuit's conversion efficiency. If the inductance amount of inductor L_{N} has a value of 1/10 of the inductance amount of first primary winding N_{P1} or second primary winding N_{P2} of the transformer, then the output voltage of the secondary winding decreases by 1/10, i.e. the output voltage is 90.0% of what it would be if no inductor is connected in series. If inductor L_{N} has a large value, then the internal DC resistance also gets large, the circuit's conversion efficiency decreases, and further, the output voltage will drop due to the impact of inductor L_{N}. If the value of inductor L_{N} is too small to approximate that of a conductor, then the short circuit protection effect is not significant. In order not to affect the circuit's output voltage while ensuring the short circuit protection effect, the value of the inductor is preferably between 1/400 and 1/20 of the inductance amount of first primary winding N_{P1} or second primary winding N_{P2}. When the inductance amount of inductor has a value less than 1/100 of the inductance amount of first primary winding N_{P1} or second primary winding N_{P2}, the impact of inductor L_{N} on the circuit's conversion efficiency is small or negligible, and in the meanwhile, the impact on the output voltage is trivial. In normal operation, inductor L_{N} is equivalent to short circuit, the converter implements push-pull oscillation operation by using magnetic core saturation characteristics, the output waveform is approximate square waves (as shown in FIG. 7), and the circuit has a high conversion efficiency. The principle is the same as the implementation principle in the prior art and thus is unnecessary to detail it here.

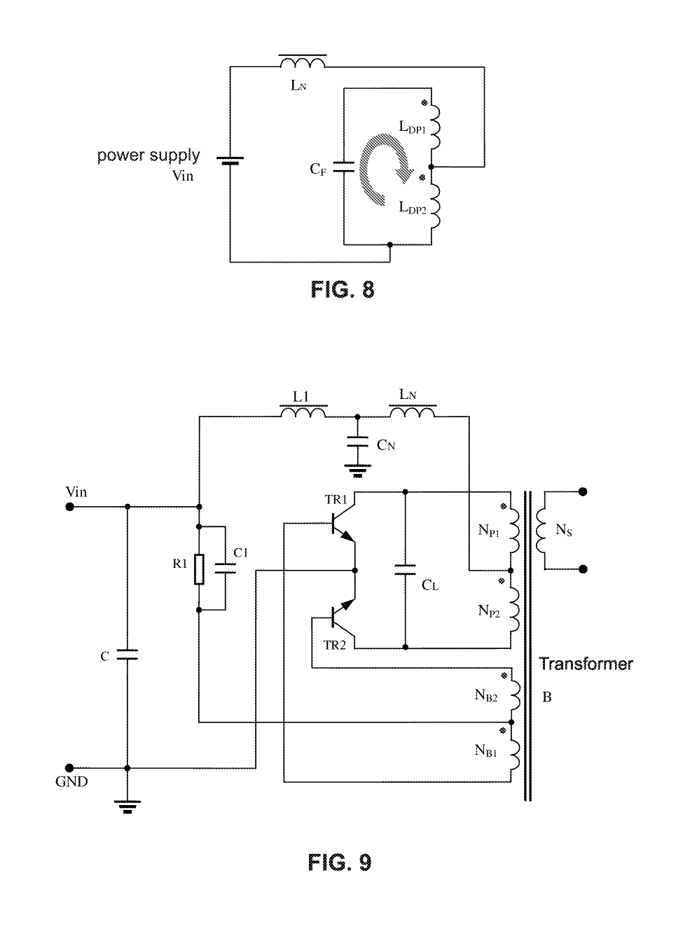

When the converter's load is short-circuited, this is equivalent to the situation where the inductance amount of first primary winding N_{P1} and second primary winding N_{P2} falls to a very small value, and the circuit enters into high-frequency self-excited push-pull oscillation. By controlling the leakage inductance of transformer B, the self-excited push-pull oscillating frequency can rise significantly. When the oscillating frequency rises, the transmission efficiency of transformer B decreases, the energy consumption of the secondary side caused by short circuit is not high, and the consumption of the primary side (first primary winding N_{P1}, second primary winding N_{P2}, first feedback winding N_{B1} and second feedback winding N_{B2}) also decreases with the rise of the self-excited push-pull oscillating frequency. After the self-excited push-pull oscillating frequency rises and the transmission efficiency of transformer B reduces, the leakage inductance caused by short circuit will rise to some extent, and eventually the oscillating frequency of the self-excited push-pull converter will be maintained at a high frequency. Due to the presence of inductor L_{N}, it results in an LC oscillating loop, an equivalent of which is shown in FIG. 8, wherein a capacitor C_{F} is the loop's distributed capacitance, comprising output capacitance of first triode TR1 and second triode TR2, distributed capacitance of transformer B as well as distributed capacitance between wires. First leakage inductance L_{DP1} and second leakage inductance L_{DP2} are leakage inductance of the two primary windings of transformer B, respectively. Since first triode TR1 and second triode TR2 are alternately turned on, one terminal in the LC oscillating loop is equivalently grounded and the other terminal is connected at supply terminal Vin via L_{N}. Due to the presence of inductor L_{N}, the LC oscillating loop is no longer amplitude-limited by a voltage inputted from supply terminal Vin. When the load is short-circuited, the circuit's operating frequency rises, and the energy oscillates in the LC oscillating loop as shown by the arrow in FIG. 8, and it needs to pass through inductor L_{N} before being absorbed by the power source through supply terminal Vin. Due to the presence of inductor L_{N}, the quality factor Q value of the LC oscillating loop is no longer dragged down by the power source, the loop can maintain oscillation without large energy supplement as its internal energy consumption is very low, and the energy is mostly consumed in secondary side load short circuit. However, if inductor L_{N} takes a too small value, the quality factor Q value of the LC oscillating loop can still be dragged down by the power source, and inductor L_{N} would play a reduced role.

For the self-excited push-pull converter as shown in FIG. 6, the operating principle of short circuit protection may be summarized as below. Inductor L_{N} is connected in a series manner in the circuit, and it exerts a small impact on the oscillation of magnetic core saturation characteristics when the circuit is operating normally. When the load is short-circuited and the circuit's oscillating frequency rises, due to the presence of inductor L_{N}, which blocks high frequencies while passes low frequencies, the energy in the oscillating loop cannot be easily absorbed by the power source and wasted, thereby improving the short circuit protection performance. By means of inductor L_{N}, whose value is elaborately adjusted and selected, in conjunction with synchronously increasing the capacitance value of starting capacitor C1 in the circuit, it is achievable that the operating current of the circuit when under short circuit protection is less than the circuit's operating current when there is no load.

In the above first embodiment of the present invention, inductor L_{N} may be formed by the wiring of a printed circuit board or by connecting a lead of the center tap of the primary windings in series with a magnetic bead or a magnetic ring. According to actual needs of the power converter, both the first and second triodes may be NPN-type triodes, PNP-type triodes (the polarity of the source input voltage needs to be reversed), monomer triodes or compound triodes.

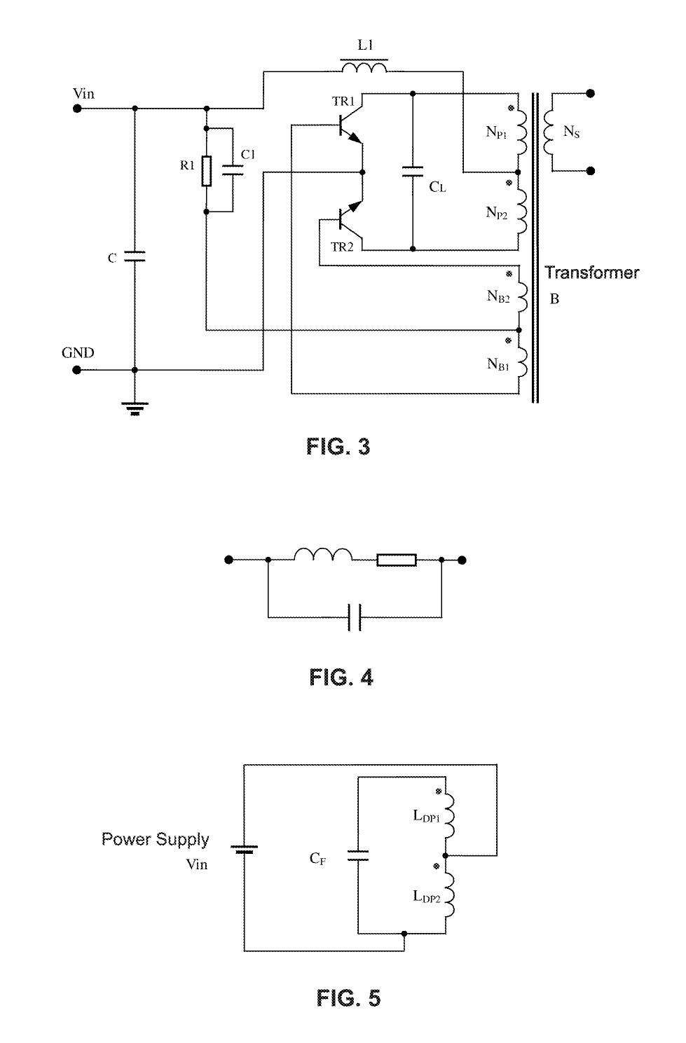

FIG. 9 shows a self-excited push-pull converter according to Embodiment 2 of the present invention, which comprises: a filter capacitor C, a bias resistor R1, a starting capacitor C1, a first triode TR1, a second triode TR2, a transformer B, a damped inductor L1, a resonant capacitor C_{L}, an inductor L_{N} as well as a capacitor C_{N}. Its circuit structure is substantially identical to that of a collector resonant Royer circuit (as shown in FIG. 3) in the prior art. The difference lies in that a supply terminal Vin is connected to a center tap of primary windings of transformer B via damped inductor L1 and newly added inductor L_{N} in that order, the inductance amount of inductor L_{N} is less than 1/10 of that of one of the primary windings (N_{P1}, N_{P2}) of transformer B, and the center tap of the primary windings is a connection point of a first primary winding N_{P1} and a second primary winding N_{P2}. An additional difference lies in that the connection point of damped inductor L1 and newly added inductor L_{N} is connected to a supply reference terminal GND via capacitor C_{N}.

When the converter operates normally, the circuit's operating frequency is relatively low. Since the inductance amount of inductor L_{N} is far less than that of first primary winding N_{P1} or second primary winding N_{P2}, inductor L_{N} has little influence on the circuit's conversion efficiency, and is equivalent to short circuit. The capacity of capacitor C_{N} is also relatively small, which is equivalent to open circuit. Therefore, inductor L_{N} and capacitor C_{N} can be neglected when the converter is operating normally. The converter implements a push-pull oscillation operation, the output waveform are sine waves or approximately sine waves. The principle is the same as the implementation principle in the prior art and thus is unnecessary to detail here.

When the converter's load is short-circuited, the circuit's oscillating frequency rises. At this point, capacitor C_{N} is equivalent to short circuit, providing a ground bypass. Damped inductor L1 functions as a power-supply source filter capacitor and, together with capacitor C_{N}, forms a filter circuit for the converter circuit, without limiting the rise of the circuit's oscillating frequency. At this point, inductor L_{N} functions in the same way as inductor L_{N} in Embodiment 1, whereby short circuit protection is achieved. The operating principle of short circuit protection in this embodiment is the same as that in Embodiment 1 and can achieve the same protection performance. It is unnecessary to detail it here again.

In Embodiment 2, inductor L_{N} may be formed by the wiring of a printed circuit board or by connecting a lead of the center tap of the primary windings in series with a magnetic bead or a magnetic ring. According to actual needs of the power converter, both the first and second triodes may be NPN-type triodes, PNP-type triodes (the polarity of the source input voltage needs to be reversed), monomer triodes or compound triodes.

To better understand the improvement and advantageous effect which the present invention has made over the prior art as described in the Background, the invention is further described below with reference to the accompanying drawings and actual measured data.

FIG. 1 is a prior art self-excited push-pull converter with a Royer circuit structure of the prior art, based on which a switching power converter is made with the following parameters: an input DC of 5V, an output DC of 5V, and an output current of 200 mA, i.e. a converter with a output power of 1 W.

The circuit's main parameter values are as below: filter capacitor C takes a value of 1 uF, bias resistor R1 takes a value of 1KΩ, starting capacitor C1 takes a value of 0.047 uF, and first triode TR1 and second triode TR2 are triodes with an amplification factor of around 200 (a maximum operating current of their collector is 1 A). The converter's secondary side output employs the full-wave rectifying circuit, wherein each of first primary winding N_{P1} and second primary winding N_{P2} has 20 turns, each of first feedback winding N_{B1} and second feedback winding N_{B2} has 3 turns, each of a first secondary winding N_{S1} and a second secondary winding N_{S2} has 23 turns, and the magnetic core of transformer B is a ferrite ring magnetic core, known as a magnetic ring, with an outer diameter of 5 mm and a cross-sectional area of 1.5 mm².

Based on the actual measurement of the above circuit, the measured parameters of the prior art self-excited push-pull converter of a Royer circuit structure were obtained as shown in Table 1:

TABLE 1

| | | Prior Art | |
|---|---|---|---|
| | | | during short circuit, |
| | | no-load current | circuit's input joint |
| No. | Circuit Operating Voltage (V) | (mA) | current (mA) |
| 1 | 5 | 17.9 | 54 |
| 2 | 5 | 18.2 | 62 |
| 3 | 5 | 18.0 | 60 |
| 4 | 5 | 17.8 | 110 |
| 5 | 5 | 17.7 | 90 |

As seen from Table 1, when the load is short-circuited, the short circuit protection current consistency of the self-excited push-pull converter in the prior art is rather poor, because the leakage inductance consistency can be difficult to maintain when winding the transformer.

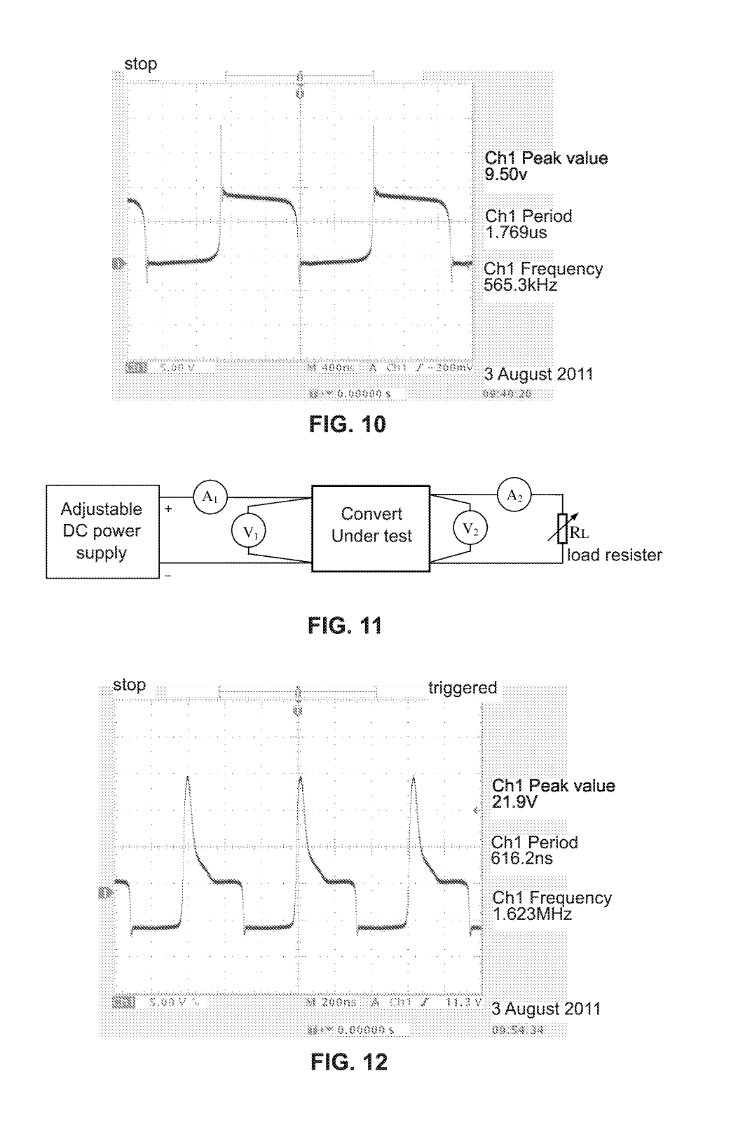

When the converter's load is short-circuited, an output waveform as shown in FIG. 10 is obtained by waveform-observing the collector of first triode TR1 in the above circuit. It can be seen that when first triode TR1 is saturation turned on, a voltage at its collector is almost 0V; when second triode TR2 is saturation turned on, due to the action of transformer B, the collector voltage of first triode TR1 is at one time as large as a source voltage of supply terminal Vin, i.e. 9.50V. In the meanwhile, it can be seen that upon load short circuit, the circuit's oscillating frequency rises to 565.3 KHz from 34.56 KHz (as shown in FIG. 7) during the circuit's normal operation, rising by 16 times.

The self-excited push-pull converter based on Embodiment 1 is shown in FIG. 6. It takes the same parameter values in Table 1 for the same parts of the prior art converter shown in FIG. 1. After completion of the actual measurement of the prior art circuit, inductor L_{N} is then added. Now, the inductance amount of the first primary winding N_{P1} and second primary winding N_{P2} were measured to be the same: about 206 uH. According to the requirements of Embodiment 1, the inductance amount of inductor L_{N} should take a value of less than 20.6 uH. For the actual measurement conducted, inductor L_{N} had a value of 0.6 uH, which was 1/340 of the first primary winding.

Based on the actual measurement, the results obtained on the converter of Embodiment 1 are shown in Table 2:

TABLE 2

| | | | | After Inductor Series In | |
|---|---|---|---|---|---|
| | | | | (Embodiment 1) | |
| | | Prior Art | | | during short |
| | | | during short | | circuit, |
| | | | circuit, | | circuit's |
| | Circuit | | circuit's input | no-load | input joint |
| | Operating | no-load current | joint current | current | current |
| No. | Voltage (V) | (mA) | (mA) | (mA) | (mA) |
| 1 | 5 | 17.9 | 54 | 17.9 | 34 |
| 2 | 5 | 18.2 | 62 | 18.2 | 35 |
| 3 | 5 | 18.0 | 60 | 18.0 | 37 |
| 4 | 5 | 17.8 | 110 | 17.8 | 38 |
| 5 | 5 | 17.7 | 90 | 17.7 | 36 |

| | | | | |
|---|---|---|---|---|
| mean value | 17.9 | 75.2 | 17.9 | 36 |

As shown in Table 2, in all the five measurement, the joint operating current of the converter was reduced to below 38 mA when the load is short-circuited, and good consistency is achieved, with the mean values reduced to 36 mA from 75.1 mA.

By connecting a load resistor of 25Ω at the circuit and using an efficiency test circuit shown in FIG. 11, the self-excited push-pull converter circuits of the prior art is compared to the one based on Embodiment 1 when the converter is operating normally. Voltmeter V1 tests the operating voltage Vin, i.e. input voltage and ammeter A1 tests the input current Iin, i.e. operating current. Voltmeter V2 tests the output voltage Vout and ammeter A2 tests the output current lout. The results obtained are shown in Table 3 below:

TABLE 3

| | Circuit | | After Inductor Connected |
|---|---|---|---|
| | Operating | Prior Art | Serially (Embodiment1) |
| No. | Voltage (V) | Conversion Efficiency (%) | Conversion Efficiency (%) |
| 1 | 5 | 78.6 | 78.5 |
| 2 | 5 | 79.1 | 79.1 |
| 3 | 5 | 77.9 | 77.9 |
| 4 | 5 | 79.4 | 79.3 |
| 5 | 5 | 78.9 | 78.9 |

Where the conversion efficiency in Table 3 is calculated by Equation (2).

The circuit's conversion efficiency is:

$$η = \frac{Vout \times Iout}{Vin \times Iin} \times 100 \% \qquad Equation ( 2 )$$

In Equation (2), Vin is the operating voltage, Iin is the input current, Vout is the output voltage, and lout is the output current.

As seen from Table 3, for the convert of Embodiment 1, after an appropriate inductor is connected in series, little influence is exerted on the efficiency, the short circuit protection performance consistency is good, it is easy to perform adjustments, and the fabrication and production process of the transformer is simple. Particularly, for Sample 4, as the transformer leakage inductance is small, when the load is short circuited, the operating current is 110 mA for the prior art converter but drops to 36 mA for the converter based on Embodiment 1.

When the transformer load is short-circuited, an output waveform as shown in FIG. 12 can be obtained by waveform-observing the collector of first triode TR1 in the circuit based on Embodiment 1. It can be seen that when first triode TR1 is saturation turned on, its collector voltage is nearly 0V; when second triode TR2 is saturation turned on, due to the action of transformer B, the collector voltage of first triode TR1 is several times as large as the source voltage, i.e. 21.90V. The fact that such a high peak value is produced indicates inductor L_{N} contributes and the circuit's L_{C} oscillating loop (as shown in FIG. 8) also resonates. Therefore, the advantageous effect as described in Table 2 is achieved, and the mean value of the short circuit protection current falls from 75.1 mA to 36 mA. The circuit's oscillating frequency rises to 1623 KHz from 34.56 KHz (as shown in FIG. 7) of normal circuit operation, i.e. rises by 46 times. In the prior art, the oscillating frequency rises to 565.3 KHz, i.e. rises by 16 times. Therefore, the present invention causes the oscillating frequency to further rise during short circuit. When the load is restored to normal operation from short circuit, the self-excited push-pull converter circuit (as shown in FIG. 6) according to Embodiment 1 may also restore by itself to oscillation due to magnetic core saturation characteristics and afterwards, the operating frequency is low, and inductor L_{N} exerts almost no impact on the circuit operation because the inductance amount is small.

Table 4 shows the results of another actual measurement which was conducted similarly to the measurement related to Table 2. The difference lies in that in the previous measurement, inductor L_{N} of the converter (see FIG. 6) took a value of 0.6 uH while for the Table 4 measurement, it took a value of 20.6 uH, 1/10 of the primary winding.

TABLE 4

| | | | | After Inductor Connected | |
|---|---|---|---|---|---|
| | | | | Serially (Embodiment 1) | |
| | | Prior Art | | | during short |
| | | | during short | | circuit, |
| | | | circuit, | | circuit's |
| | Circuit | no-load | circuit's input | no-load | input joint |
| | Operating | current | joint current | current | current |
| No. | Voltage (V) | (mA) | (mA) | (mA) | (mA) |
| 1 | 5 | 17.9 | 54 | 17.9 | 33 |
| 2 | 5 | 18.2 | 62 | 18.2 | 34 |
| 3 | 5 | 18.0 | 60 | 18.0 | 35 |
| 4 | 5 | 17.8 | 110 | 17.8 | 37 |
| 5 | 5 | 17.7 | 90 | 17.7 | 33 |

| | | | | |
|---|---|---|---|---|
| mean value | 17.9 | 75.2 | 17.9 | 34.4 |

As shown in Table 4, in all the five measurement, the joint operating current of the converter of Embodiment 1 was reduced to below 37 mA when the load is short-circuited, and good consistency is achieved, with the mean value being reduced to 34.4 mA from 75.1 mA. When the inductance amount of inductor L_{N} has a value of 0.6 uH, the mean value is 36 mA (See table 2).

Similarly, by connecting a load resistor of 25Ω at the circuit and using an efficiency test circuit shown in FIG. 11, the actual operating parameters of the converter of Embodiment 1 were measured in comparison with the prior art converter and the results are shown in Table 5:

TABLE 5

| | Voltage (V) | Prior Art | After Inductor Connected |
|---|---|---|---|
| | Circuit | Conversion | Serially (Embodimentl) |
| No. | Operating | Efficiency (%) | Conversion Efficiency (%) |
| 1 | 5 | 78.6 | 77.4 |
| 2 | 5 | 79.1 | 78.1 |
| 3 | 5 | 77.9 | 76.7 |
| 4 | 5 | 79.4 | 78.9 |
| 5 | 5 | 78.9 | 78.1 |

As shown in Table 5, in the present invention after a 1/10 inductor of the primary windings is connected in series, the impact of increased induction on efficiency begins to appear, i.e. the mean value of efficiency decreases to 77.84% from 78.74% (when using 0.6 uH), a 0.9% decrease. However, a bigger impact is exerted on the output voltage. The output voltage decreases to 4.46V from 4.90V (when using 0.6 uH).

Measurements were then conducted on the self-excited push-pull converter of the prior art (FIG. 3) and the one of Embodiment 2 of the present invention (FIG. 9), wherein damped inductor L1 is a 2 mH inductor, i.e. 10 times as large as the 206 uH primary winding inductor. It was found that the prior art converter (FIG. 3) fails to fulfill the short circuit protection function, and the circuit was burned in 15 seconds. In other words, due to the presence of L1, the converter cannot realize self-protection when short circuit occurs. In contrast, the converter of Embodiment 2 (FIG. 9), with inductor L_{N} taking a value between 20.6 uH and 0.6 uH and capacitor C_{N} taking a value between 0.047 uF and 0.01 uF, delivered a good short circuit protection performance. In five measurement samples, when the secondary winding is short-circuited, the operating currents were all below 44 mA (to avoid redundancy, the test data is not presented here).

The preferred embodiments of the present invention have been presented above. By the spirit of the present invention, the present disclosure can be implemented in other manners. For example, the inductor may be serially connected at other position of the above mentioned LC equivalent oscillating loop. For other variations, the inductor may be serially connected between a connection point of the emitters of the two push-pull triodes and a power supply ground, the inductor may be serially connected between the collector of the push-pull triode and the transformer, or the two primary windings of the transformer use the inductor to connect to a center tap; the original inductor may be replaced by inductors connected in series; inductor L_{N} and capacitor C_{N} of Embodiment 2 may be serially connected in two cascades wherein the inductor and the capacitor may has different values so as to obtain a better protection performance. These embodiments can also achieve the object of the present invention and fall with the scope of the present invention.

It is therefore understood that the foregoing preferred embodiments should not be construed as limiting the present invention, and the protection scope of the present invention should be determined by the claims. Improvements and polishes may be made by those of ordinary skill in the art without departing from the scope and spirit of the present invention, which should also be regarded as the protection scope of the present invention.

1. A self-excited push-pull converter, comprising a Royer circuit, characterized in that an inductor is further connected between a supply terminal of said Royer circuit and a center tap of primary windings of a transformer in said Royer circuit, said inductor having an induction amount less than 1/10 of that of one of the primary windings of the transformer, and the center tap of said primary windings being a connection point between two primary windings of said transformer.

2. The self-excited push-pull converter according to claim 1, wherein said inductor is formed by a wiring of a printed circuit board.

3. The self-excited push-pull converter according to claim 1, wherein said inductor is formed by connecting a lead of the center tap of said primary windings in series with a magnetic bead or a magnetic ring.

4. A self-excited push-pull converter, comprising a collector resonant Royer circuit, characterized by further comprising an inductor and a capacitor, wherein a center tap of primary windings of a transformer in said collector resonant Royer circuit is connected to a supply terminal of said collector resonant Royer circuit via said inductor and a damped inductor in said collector resonant Royer circuit, said inductor having an inductance amount less than 1/10 of that of one of the primary windings of the transformer, the center tap of said primary windings being a connection point between two primary windings of said transformer, and a connection point between said damped inductor and said inductor being connected via said capacitor to a supply reference terminal of said collector resonant Royer circuit.

5. The self-excited push-pull converter according to claim 4, wherein said inductor is formed by a wiring of a printed circuit board.

6. The self-excited push-pull converter according to claim 4, wherein said inductor is formed by connecting a lead of the center tap of said primary windings in series with a magnetic bead or a magnetic ring.
